(19) United States
(12) Patent Application Publication
(10) Pub. No.: US 2005/0097222 A1
(43) Pub. Date: May 5, 2005

(54) System and method for call routing in an ip telephony network

(76) Inventors: Wenyu Jiang, San Francisco, CA (US); Jonathan Lennox, Jersey City, NJ (US); Henning Schulzrinne, New Jersey, NJ (US); Kundan Singh, New York, NY (US)

Correspondence Address: Henry Tang;Baker Botts, 30 Rockefeller Plaza, New York, NY, 10112, US

(21) Appl. No.: 10/480,505

(22) PCT Filed: Jun. 12, 2002
(86) PCT No.: PCT/US02/18753

Related U.S. Application Data
(60) Provisional application No. 60/297,659, filed on Jun. 12, 2001.

(51) Int. Cl. G06F 15/16; G06F 15/173

(52) U.S. Cl. 709/245; 709/238

(57) ABSTRACT

A method of processing a call request to a callee in a network telephony system is provided which includes mapping a hostname portion of a callee address to a canonical form of the hostname and determining a canonical form of a username portion of a callee address. The canonical form of the user identity of the callee is then used as an index to a user database to retrieve a callee database record. The callee database record is then used to determine call routing based on the retrieved callee database record, such as user location, preferences and policy data stored in the record. The method is generally performed by a signaling server in the network, such as a SIP proxy server. The signaling server can also provide security features such as caller authentication. A scalable signaling and routing architecture is also provided.

This application claims the benefit of United States Provisional Applications, Ser. No. 60/297,659, entitled TOWARDS JUNKING THE PBX: DEPLOYING IP TELEPHONY, was filed on Jun. 12, 2001, which is hereby incorporated by reference in its entirety.

### FIELD OF THE INVENTION

The present invention relates generally to the field of Internet and intranet (IP) telephony and more particularly relates to a network telecommunications system for performing call routing and security operations in such a network.

### BACKGROUND OF THE INVENTION

The Internet has evolved into an essential communication tool for millions of users in the business, technical and educational fields. In this regard, a growing use of the Internet relates to Internet protocol (IP) telephony which provides a number of advantages over conventional circuit-switched network telephony systems that are controlled by a separate signaling network.

The session initiation protocol (SIP) is gaining in popularity as a standard signaling protocol for use in Internet telephony. As this popularity grows, it will be increasingly desirable to provide a system architecture and method for providing improved services in SIP based systems. Among these services are improved call routing within a network. Such improved call routing functionality can serve to replace or otherwise reduce the system reliance on traditional multi-line Public Branch Exchange (PBX) systems. In addition to call routing functionality, the conventional PBX will generally also provide a measure of security within a telephony system, such as controlling access to the toll lines to authorized users. Therefore it is desirable to provide a network architecture and operating methods which allow a SIP based telephony network to provide security controls on outgoing calls to the toll lines. There is a potentially limitless range of SIP user identifiers that can be used. It is also desirable for such a system to provide authentication of users for incoming calls as an additional security feature.

### SUMMARY OF THE INVENTION

It is an object of the present invention to provide improved systems and methods for call routing in a SIP compliant telephony system.

A method of processing a call request to a callee in a network telephony system in accordance with the present invention includes mapping a hostname portion of a callee address to a canonical form of the hostname; determining a canonical form of a username portion of the callee address; applying the canonical form of the hostname and username as an index to a user database to retrieve a callee database record; and determining routing of the call request based on the retrieved callee database record. Preferably, the hostname mapping operation is performed by comparing the hostname portion of the callee's address to a range of addresses for the associated hostname.

The operation of determining the canonical form of the username portion preferably includes determining whether the username corresponds to a known alias, a known e-mail address or can be resolved using a name mapping operation. Such operations can be used individually or in combination. In addition, a dial plan translation operation can be used to determine call routing for addresses which are in the form of a telephone number.

Preferably, the method is a computer based method which is performed in a signaling server of a telephony network.

In addition to call routing, the present methods can also include caller authentication. Such caller authentication can include the steps of rejecting an initial call request from an unknown caller. An email message is then sent to the address corresponding to the identity of the caller which includes an authentication message. The caller then reinitiates a call request using the received authentication message to verify the caller's identity. The email message can also include a link to facilitate the subsequent call request.

A scalable telephony network for routing call requests in an IP telephony network is also provided. The scalable telephony network includes at least one first stage signaling server which receives call requests from callers. At least two second stage signaling servers are provided, each of which maintain a database of a subset of users of the network based on a predetermined property of the user identity. The second stage signaling servers are provided with a portion of the call requests from the at least one first stage signaling server in accordance with the predetermined property of the user identity of the callee. For example, calls can be routed by the first stage servers to the particular second stage servers based on the hash of the callee's identifier.

### BRIEF DESCRIPTION OF THE DRAWINGS

For a complete understanding of the present invention and the advantages thereof, reference is now made to the following description taken in conjunction with the accompanying drawings in which like reference numbers indicate like features and wherein:

FIG. 1 is a block diagram of a telephony system employing the session initiation protocol (SIP);

FIG. 2 is a flow chart illustrating a method of processing an incoming call using canonicalization to provide authentication and call routing in the present system; and

FIG. 3 is a simplified block diagram illustrating an overview of a two-stage network topology suitable for scaling a system to a large number of users.

### DETAILED DESCRIPTION OF THE INVENTION

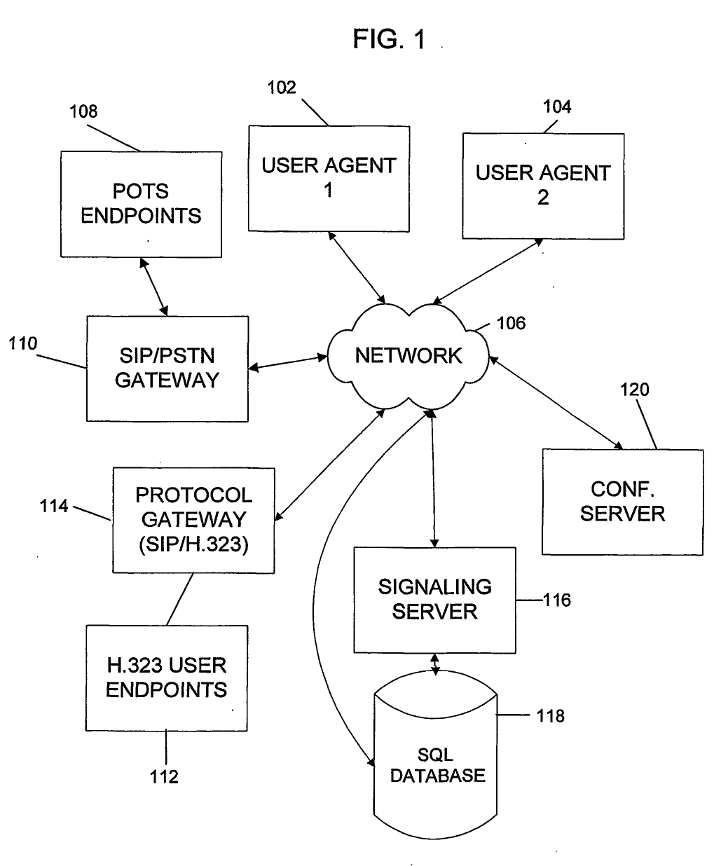

FIG. 1 is a simplified block diagram illustrating the architecture of a system for performing telephony services, including call routing and security services, in connection with an Internet telephony system.

The system of FIG. 1 preferably operates primarily in accordance with the session initiation protocol (SIP) for signaling and control functions. In addition, it is preferable for the system to include provisions for accommodating other signaling protocols to provide for conferencing and other telephony services between or among various forms of telephony endpoints. Media being transported in a network telephony system generally includes audio, video, text, graphics and other data which can be transmitted via packet data. In data network telephony systems, media is generally transported using the real time protocol (RTP), which is known in the art.

The system will generally include a large number of telephony endpoints, which preferably take the form of SIP user agents. For illustrative purposes, two such user agents 102, 104 are illustrated. The user agents 102, 104 can take on many forms, such as stand alone SIP telephony devices, which are available from a number of sources or SIP client software operating on a conventional personal computer, such as the SIPC software available for license from Columbia University, New York, N.Y. Suitable SIP user agents are described in international patent publication WO 00/76158 entitled “Network Telephony Appliance and System for Inter/Intranet Telephony” published on Dec. 14, 2000, which is hereby incorporated by reference in its entirety.

The SIP user agents 102, 104 are coupled to a data network 106, such as an Ethernet network. The network can be a local area network (LAN), wide area network (WAN) or even the Internet with user agents grouped in a virtual network under one or more Internet domains. The user agents 102, 104 can access one another directly via network 106 (internally, peer-to-peer), or externally from another Internet domain. SIP user agents 102, 104 can also access non-SIP based telephony endpoints, such as conventional telephones (POTS endpoints 108) via a SIP/PSTN gateway 110 or H.323 based Internet telephony endpoints 112 via a SIP/H.323 protocol gateway 114.

SIP user agents are capable of direct point-to-point call sessions. However, the system can also include a signaling server 116 which responds to call requests from a SIP user agent 102, 104 and identifies the location(s) of a called party. Preferably, the signaling server 116 is a SIP server which can perform proxy and redirect signaling operations. In SIP, each telephony endpoint can be referred to as a node and has one or more SIP address. By employing this SIP address of an endpoint, a node acting as a calling party can directly initiate a call session with any other node on the network. The signaling server 116 can be accessed by the various user agents 102, 104 on the network to provide enhanced services, such as a directory service, call forwarding, call branching, call messaging and the like. For example, a calling party wishing to initiate a call to JOHN SMITH can enter the SIP address for that person if it is known, such as sip:john.smith@work.com. If, on the other hand, the calling party does not know the SIP address of the party, the calling party can contact the signaling server 116 with a request to begin a session with JOHN SMITH. In this regard the system will maintain a database, such as SQL database 118, for storing the current network addresses and phone numbers where the users can be reached. The SQL database 118 can also store other user-specific data which related to user options and preferences, such as voice mail and conferencing preferences.

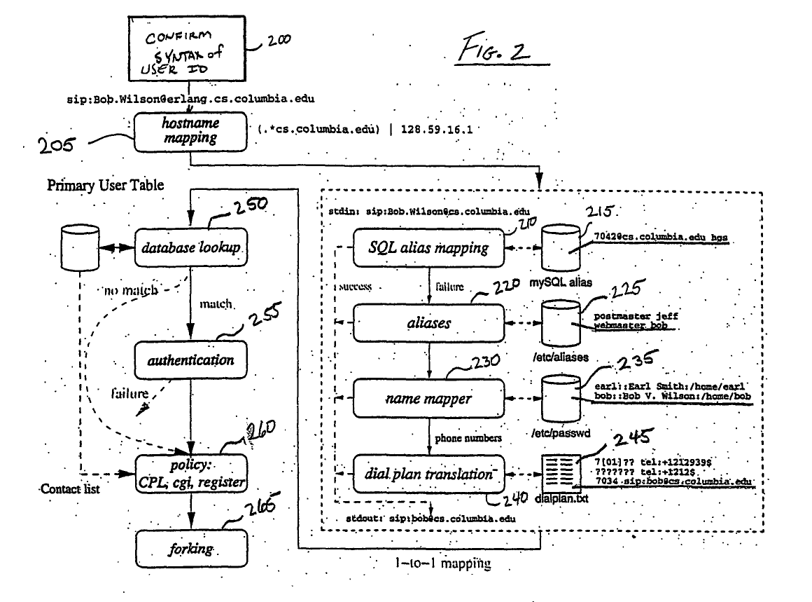

FIG. 2 is a flow chart illustrating a method for processing an incoming call in accordance with the present invention. A benefit of internet telephony systems is that a user can be reached in a number of different ways. For example, a called party (callee) may have multiple identifiers such as john.smith@cs.columbia.edu; john.smith@home, john.smith@office, john.smith@lab and the like. Each of these various identifiers correspond to a common unique identifier in the system in the form user domain, which can be referred to as a canonical user identifier. The canonical user identifier can serve as an index for the SQL database 118.

Referring to FIG. 2, upon detection of an incoming call by the signaling server 116 to a SIP user agent, such as bob.wilson@erlang.cs.columbia.edu, the signaling server validates the syntax of the call request (step 200). The signaling server then attempts to transform the address of the party being called (callee) to a canonical user identifier for efficient database lookup in the SQL database and subsequent call handling. This operation includes a host name mapping operation (step 205) wherein the host portion of the callee address is evaluated. For example, the host name portion (erlang.cs.columbia.edu) can be compared against a regular expression such as (128.59.(1[6-9] 2[0-3]).[0-9]*) which maps all host names and IP addresses in the range from 128.59.16.0 to 128.59.23.255 within the domain CS to the canonical server address of cs.columbia.edu.

In the event that the canonicalized host name does not match the host name mapping expression, the server will operate as “outbound proxy server” for the identifier of the callee and will simply route the request to the SIP server for the specified domain without any processing of the identifier of the callee. In outbound proxy server mode, the signaling server 116 can provide call logging functions as well as firewall control operations. In addition, while not necessary for call requests which use actual SIP URL syntax, an outbound proxy server is required for those SIP requests which use “tel” URL's in order to translate the SIP telephone number into a routable SIP identifier. A tel URL is one which identifies E.164 telephone numbers, such as tel:+1-234-555-1234. The SIP identifier can be at a PSTN gateway or can be a sip URL in the form sip:user@host.

Following the hostname mapping operation (step 205), the signaling server 116 continues processing of the incoming call request by passing the username portion of the callee address to a coprocess operation which will be referred to herein as “canonicalize” that translates username portion of the address to its canonical form. The canonical form reduces the many to one mapping of user identities that are possible in the SIP architecture to a one to one mapping between the callee and the callee's SQL database records.

A number of methods can be used for translating the usernames to the canonical form. These methods can be used individually or in a hierarchical rule based structure as illustrated in FIG. 2. As illustrated in FIG. 2, for example, the canonicalize process can query the SQL database 118 to determine if the current user name represents a known alias in a an alias mapping table (step 210). For example, database entry 215 illustrates that the alias 7042@cs.columbia.edu maps to the user hgs. If there is a match in step 210, the process returns the canonical identifier associated with the alias from the SQL database. If there is no match in the SQL alias database 118, the canonicalize process can continue by querying an e-mail alias table in the SQL database to determine if there is a matching entry for the current username (step 220). Such an e-mail alias database table generally includes functional aliases, such as “postmaster,” “webmaster,” and the like, as illustrated by sample table entries 225.

If there are no matches for the current callee username in either the SQL alias table or the email alias table, then the canonicalize process can continue to apply a name mapper process which searches a system password or other user registration file 235 to determine if the username can be resolved to canonical form by comparing the request URI to various combinations of first and last name in the file (step 230). If there is still no match and the user identifier has the form of a telephone number, such as sip:1234@cs.columbia.edu or is in the form of a tel URL, the canonicalize process can perform dial plan transformations 245 in order to route the incoming call request (step 240). The dial plan transformations use a mapping of telephone numbers and or tel URL's to a particular user identifier. If none of the hierarchical rules of steps 210, 220, 230 or 240 results in a match, the username identifier is returned to the primary process of the server 116 unresolved to a canonical form.

The SIP server uses the results of the canonicalize process, which is the canonical form of the callee address, as an index to retrieve user contact and policy information for the identified callee from the SQL database 118 (step 250). The policy information describes how an incoming call is to be handled for that callee. For example, whether a call is proxied or redirected can be defined within a user's policy information. In addition, user preferences such as caller authentication, conditions determining whether to accept, reject or reroute calls from unknown callers, the callee's preferred call locations and the like can also be components of a user's policy information.

If the canonical form of the callee address results in match in the SQL database, the server 116 uses the user's policy information to determine whether such policy permits the current incoming call to be received. The server performs authentication of the calling party (step 255). If the calling party is authenticated, the server determines whether and how the call is to be routed based on the callee's policy data (step 260). If the policy data allows the call to be completed, the signaling server uses the callee's set of registered locations from the SQL database 118 and routes a call request accordingly, such as by using a forked proxy to each of the current locations for the callee (step 265).

A suitable signaling server 116, in the form of a SIP proxy server, can be implemented using the SIPD software available from Columbia University, New York, N.Y.

A telephony system in accordance with the present invention can also include a conferencing server 120 which is coupled to the signaling server 116, user agents 102, 104 and gateways 110, 114 via the data network 106. A number of conferencing participants will establish call sessions with the conferencing server 118, receive media streams from such participants and then mix and distribute the media streams as appropriate to enable the conferencing functions. While shown in FIG. 1 as separate operational blocks, the gateways 110, 114, signaling server 116 and conferencing server 118 can be integrated into a single server/gateway unit or distributed throughout the system in various hardware topologies. Whether such functionality is consolidated or distributed is not critical to the present invention.

The conferencing server 118 is a centralized conferencing server which receives media streams from a number of conference participants, decodes the media streams, mixes the audio component of the media streams and encodes and distributes mixed streams to the conference participants. Preferably, the conferencing server is capable of directly conferencing endpoints which employ different signaling protocols, such as H.323 and SIP, as well as different media CODEC protocols such as G.711, DVI ADPCM, GSM and the like. The media streams are generally conveyed using the real time transport protocol (RTP) in both H.323 and SIP.

A significant consideration in an IP telephony system involves network security. This includes the registration of users, the handling of remote callers and controlling access from the network to the PSTN. It is desirable to authenticate user registrations in order to insure that all users of the network are authorized users. In this regard, for known users, digest authentication can be used where a shared secret between the server and the caller is verified via a challenge-response exchange. In addition, it is desirable to have the ability to authenticate the identity of outside callers to the network.

One method of establishing a level of user authentication is to confirm a mapping between a caller's SIP identity and the caller's e-mail identity. For an unknown caller, the call is not initially accepted. Instead, the caller's identity is treated as an e-mail address and an e-mail message is sent to this address. The e-mail message includes a randomly generated password as well as a link to the originally called SIP URL. To establish the call, the caller reinitiates the call request to the callee after receiving the e-mail message, such as by activating the link sent in the message, and then uses the password in the received message for authentication. The e-mail message can be stored by the caller for future caller authentication to that callee.

An additional security consideration involves restricting the access and use of the PSTN gateway to insure that only authorized users can initiate toll calls outside of the network. This function can be performed at the signaling server 116 by authenticating users' initiating outgoing calls against the user's assigned rights prior to passing the call request to the SIP/PSTN gateway. In addition, in the case of a gateway which includes access control features, such as a gateway formed using a Cisco 2600 router with an Internetwork Operating System (IOS), an IOS access control lists feature can be used to accept only those SIP requests from the SIP proxy server while still accepting UDP media streams from all potential users. In this way, direct calls which attempt to bypass the signaling server 116 can be rejected.

It is desirable for an Internet telephony network to be scalable such that the system can be extended to accommodate a large number of users in a manner that peak system loads are handled effectively. The SIP protocol lends itself to distributing server resources throughout a network. In a small system, each of the servers can maintain full user registration database information and calls can be randomly distributed among the servers in the network to share the current system load. Since all of the servers need to share common registration information, however, such simple randomization is impractical for large systems when the task of replicating SIP REGISTER requests, which occur periodically for each user, will add considerable overhead and consume a substantial portion of the available system bandwidth.

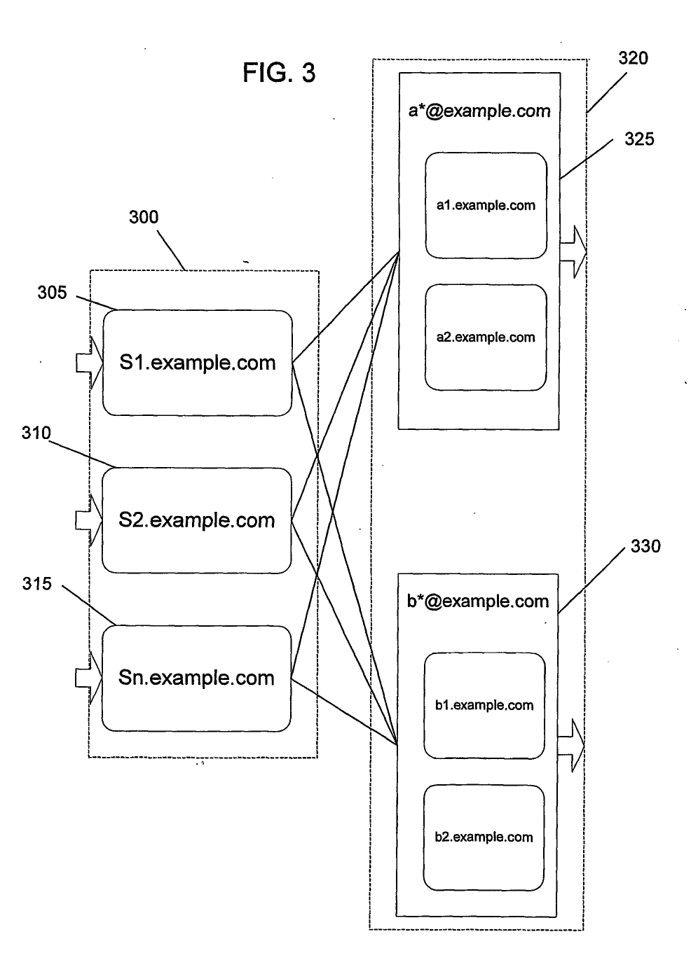

FIG. 3 is a simplified block diagram illustrating a two-stage scaling architecture which provides efficient scalability for an IP telephony system. In this architecture, the domain server group is divided into two parts. A first stage 300 is formed as a set of stateless proxy servers, designated as S1.example.com 305, S2.example.com 310 and Sn.example.com 315. The first stage 300 can include more or less than the three exemplary servers depicted in the figure. A second stage 320 is formed as a set of server or server clusters coupled with each of the stateless proxy servers of the first stage 300. The second stage servers or server clusters 320 are designated a*@example.com 325, b*@example.com 330, etc. Each server cluster 320 can take the form of a single server or for improved reliability, a group of servers, where * represents an integer number uniquely identifying each server within the cluster such that a DNS SRV resource record list can determine each member of the associated cluster.

The first stage servers 300 perform simple stateless request routing of incoming calls. For example, routing can be based on a hash, or other defined relationship, of the user identifier, with each hashing range mapping to a particular second stage server or server cluster. The second stage servers or server clusters 320 maintain the registration information for the system users. However, unlike the case with random distribution of incoming calls to distributed signaling servers, each of the second stage servers will receives call requests for a predicable subset of the users in the system from the first stage proxy servers 300. Therefore, the second stage servers need only maintain the SQL database data for the particular subset of users it may be responsible for.

Each of the servers within a particular second stage server cluster a*, b*, etc., will maintain common registration information and can provide a level of service redundancy. A particular server is selected from the cluster selected cluster in accordance with DNS SRV resource record lists which establish a priority among the servers in a cluster. For example, as an incoming call is received by the first stage 300, the hash of the user identifier can be calculated and the second stage server cluster selected. If the a cluster 325 is selected, for example, the DNS SRV resource record list is then used to select either the a1 server or a2 server from the a* cluster 325.

The present invention provides a method for routing a call request by determining the canonical form of the callee address and determining the callee policy and contact information based on the canonical form of the callee address. Call routing is determined based on the callee policy and contact information. The present systems and methods also provide for security features in a SIP telephony system, including authentication of unknown callers. A scalable network architecture is also provided for performing distributed call routing in a SIP telephony network.

The present invention has been described in accordance with certain preferred embodiments thereof. It will be appreciated that various changes and modifications can be effected by those skilled in the art and that such modifications are within the scope and spirit of the present invention as defined by the claims appended hereto.

1. A method of processing a call request to a callee in a network telephony system comprising:
mapping a hostname portion of a callee address to a canonical form of the hostname;
determining a canonical form of a username portion of the callee address;
applying the canonical form of the hostname and username as an index to a user database to retrieve a callee database record; and
determining routing of the call request based on the retrieved callee database record.

2. The method of processing a call request to a callee as defined by claim 1, wherein the hostname mapping operation includes comparing the hostname portion against a range of addresses for an associated domain.

3. The method of processing a call request to a callee as defined by claim 1, wherein the step of determining a canonical form of a username portion of a callee address includes determining whether the username portion corresponds to a known user alias.

4. The method of processing a call request to a callee as defined by claim 1, wherein the step of determining a canonical form of a username portion of a callee address includes determining whether the username portion corresponds to a known e-mail alias.

5. The method of processing a call request to a callee as defined by claim 1, wherein the step of determining a canonical form of a username portion of a callee address includes determining whether the username portion can be associated with a first name, last name combination stored in a user registration file.

6. The method of processing a call request to a callee as defined by claim 5, wherein the user registration file includes a password file.

7. The method of processing a call request to a callee as defined by claim 1, wherein the step of determining a canonical form of a username portion of a callee address includes determining whether the username portion corresponds to a telephone number recognized in a dial plan translation table.

8. The method of processing a call request to a callee as defined by claim 1, wherein the step of determining a canonical form of a username portion of a callee address includes determining whether the username portion corresponds to one of a known user alias; a known e-mail alias, a first name-last name combination from a user registration table, and a telephone number recognized in a dial plan translation table.

9. The method of processing a call request to a callee as defined by claim 1, wherein the callee database record includes callee contact data and callee preference data for routing incoming call requests.

10. The method of processing a call request to a callee as defined by claim 1, further comprising the step of authenticating a caller prior to routing of the call request.

11. The method of processing a call request to a callee as defined by claim 10, wherein for an unknown caller, the step of authenticating a caller comprises:
rejecting the initial call request;
transmitting an authentication message to an email address corresponding to a user identity of the caller; and
if the authentication message is received by the caller, receiving the authentication message from the caller in a subsequent call request from that caller.

12. A computer based process for a signaling server for routing call requests in a network telephony system comprising:
mapping a hostname portion of a callee address to a canonical form of the hostname;
determining a canonical form of a username portion of a callee address;
applying the canonical form of the hostname and username as an index to a user database to retrieve a callee database record; and
determining routing of the call request based on the retrieved callee database record.

13. The computer based process for a signaling server for routing call requests in a network telephony system as defined by claim 12, wherein the step of determining a canonical form of a username portion of a callee address includes evaluating a plurality of database tables to determine whether the username portion corresponds to one of a known user alias; a known e-mail alias, a first name-last name combination from a user registration table, and a telephone number recognized in a dial plan translation table.

14. The computer based process for a signaling server for routing call requests in a network telephony system as defined by claim 12, wherein the hostname mapping operation includes comparing the hostname portion against a range of addresses for an associated domain.

15. The computer based process for a signaling server for routing call requests in a network telephony system as defined by claim 12, wherein the step of determining a canonical form of a username portion of a callee address includes determining whether the username portion corresponds to a known user alias.

16. The computer based process for a signaling server for routing call requests in a network telephony system as defined by claim 12, wherein the step of determining a canonical form of a username portion of a callee address includes determining whether the username portion corresponds to a known e-mail alias.

17. The computer based process for a signaling server for routing call requests in a network telephony system as defined by claim 12, wherein the step of determining a canonical form of a username portion of a callee address includes determining whether the username portion can be associated with a first name, last name combination stored in a user registration file.

18. The computer based process for a signaling server for routing call requests in a network telephony system as defined by claim 17, wherein the user registration file includes a password file.

19. The computer based process for a signaling server for routing call requests in a network telephony system as defined by claim 12, further comprising the step of authenticating a caller prior to routing of the call request.

20. The computer based process for a signaling server for routing call requests in a network telephony system as defined by claim 13, wherein for an unknown caller, the step of authenticating a caller comprises:
rejecting the initial call request;
transmitting an authentication message to an email address corresponding to a user identity of the caller; and
if the authentication message is received by the caller, receiving the authentication message from the caller in a subsequent call request from that caller.

21. A scalable telephony network for routing call requests in an IP telephony network comprising:
at least one first stage signaling server, the at least one first stage signaling server receiving call requests from callers;
at least two second stage signaling servers, each of the at least two second stage signaling servers maintaining a database of a subset of users of the network based on a predetermined property of the user identity, the at least two second stage signaling servers being provided with a portion of the call requests from the at least one first stage signaling server in accordance with the predetermined property of the user identity of the callee.
